(19) United States
(12) Patent Application Publication
(10) Pub. No.: US 2012/0121960 A1
(43) Pub. Date: May 17, 2012

(54) Battery with a Moveable Membrane Separating a Cathode and Anode Cavity

(76) Inventors: David R. Hall, Provo, UT (US); Eric Gardner, Provo, UT (US); Dean Wheeler, Provo, UT (US); Grant Evans, Provo, UT (US); Paul Alfred, Provo, UT (US)

(21) Appl. No.: 12/946,952

(22) Filed: Nov. 16, 2010

(51) Int. Cl. H01M 2/00; H01M 10/058; H01M 10/50

(52) U.S. Cl. 429/120; 429/163; 429/149

(57) ABSTRACT

In one aspect of the invention, a rechargeable battery has a cathode cavity formed in a cathode housing and a anode cavity in a anode housing. A moveable membrane is disposed between the cathode cavity and the anode cavity. The cathode cavities are filled with an electrolyte.

### BACKGROUND OF THE INVENTION

The present invention relates generally to rechargeable batteries and especially to rechargeable batteries for use in environments with high temperatures and pressure, such as in oil and gas drilling. Over the years, drilling depths have increased resulting in prolonged periods that downhole batteries are exposed to the high temperature, downhole environment.

In deep wells, an instrumented bottom hole assembly is critical. Unfortunately, battery life of current instrumentation is shorter than drill bit life, thereby requiring, in some case, operators to trip out the drill string more frequently than desired. These multiple trips result in longer drilling times and more expensive drilling operations. At least some batteries currently used for downhole applications comprise non-rechargeable cells based on lithium thionyl chloride chemistry and have limited operating temperature ranges.

The prior art discloses some batteries configured for downhole use. For example, U.S. Pat. No. 6,187,469 to Marincic et al., which is herein incorporated by reference for all that it contains, discloses a battery system provides energy to operate the measurement devices associated with drilling. The system includes a plurality of cells, each comprising an electrically insulating mandrel which is shaped to fit over an inner tube, and a combination of an anode, a cathode and a solid polymer electrolyte, all disposed over the mandrel. The individual cells are mounted end to end and are interlocked together to prevent rotation of the cells relative to one another. The cells are electrically connected together and they are all mounted between an inner and an outer tube.

U.S. Patent Publication No. 2007/0003831 to Fripp et al., which is herein incorporated by reference for all that it contains, discloses an oilfield molten salt battery. The battery includes an outer case, an elongated mandrel positioned within the outer case, and the mandrel being an electrical component of the battery. Another battery includes an electrical pickup, and a polymer insulator providing insulation between the outer case and the pickup. A method of charging a battery for use in a subterranean well includes the steps of: providing the battery including an electrolyte, and anode and cathode electrodes, the electrolyte being a molten salt comprising lithium salt, and at least one of the electrodes comprising lithium atoms; positioning the battery within a wellbore; and then charging the battery. Another method includes the steps of: heating the lithium ion molten salt battery; then charging the battery; and then positioning the battery within a wellbore.

U.S. Pat. No. 4,774,156 to Bones, et al, which is herein incorporated by reference for all that it contains, discloses a rechargeable electrochemical cell comprising a cell housing divided by a separator into a pair of electrode compartments, one of which contains an anode substance and the other of which contains an active cathode substance and an electrolyte. The anode and electrolyte are liquid at the operating temperature of the cell and the electrode compartments are each divided into a gas chamber communicating with an electrode chamber. The gas chamber contains an inert gas under pressure and the electrode chamber contains a liquid, namely the anode material or the liquid electrolyte. A wall of each electrode chamber is provided by the separator and each electrode chamber has a closeable bleed outlet. The cell has an operative attitude in which said bleed outlets can be used to bleed gas from the associated electrode chambers, and each electrode chamber is in communication with the associated gas chamber, such that the cell in its operative attitude has each electrode chamber completely full of liquid, and each gas chamber containing inert gas under pressure and liquid.

### BRIEF SUMMARY OF THE INVENTION

In various embodiments of the present invention, a rechargeable battery may comprise a cathode cavity, an anode cavity, a moveable membrane, and active materials. Active materials are those that participate in the intended electrochemical reactions of the battery and may be comprised of electrode materials and electrolyte materials. The cathode cavity may be formed in a cathode housing and the anode cavity may be formed in an anode housing. The moveable membrane may be disposed between the cathode and anode cavity. The electrolytes may fill the cathode and anode cavities.

The moveable membrane may be flexible or rigid. If rigid, the perimeter of the membrane may be attached to a flexible material that connects with the cathode housing, anode housing, or combinations thereof. The membrane may comprise NaSICON, β″-alumina, or other solid separator material. In some embodiments of the present invention, the moveable membrane may also be rigid and configured to slide within the cavities. In some embodiments, a perimeter of the rigid membrane may comprise a protrusion that is guided by a slot formed in the cathode housing, the anode housing, or combinations thereof. In some embodiments of the present invention, the moveable membrane is rigid and a portion of a perimeter of the membrane forms a hinge with the cathode housing, the anode housing, or combinations thereof.

The cathode and anode housing may comprise a conductive material. A layer of closed cell foam and/or a compressible material may be disposed within the cathode cavity. The foam or other compressible material may partially fill the volume of the cathode cavity. In some embodiments, the compressible material may fill a volume from 0.01 to 50% of the anode cavity, the cathode cavity, or combinations thereof. The cathode and anode cavities may comprise substantially no direct contact between active materials and volume containing gas or vapor. The electrolyte and electrode within the cathode cavity may comprise a mixture containing sodium, nickel, and chlorine.

The rechargeable battery may further comprise at least one heating element adjacent to the cathode or anode housing. Internal heating methods may reduce deleterious thermal processes during transient heating and may also be more energy efficient. A layer of thermal insulation may surround the at least one heating element and the cathode and the anode housing. The cathode housing of a first rechargeable battery may be in connection with the anode housing of a second rechargeable battery. An electrical insulator may be disposed between the cathode housing of the first and second rechargeable battery and also between the anode housing of the first and second rechargeable battery.

### BRIEF DESCRIPTION OF THE DRAWINGS

FIG. 1 is a cutaway view of an embodiment of a downhole drill string suspended from a drill rig.

FIG. 2 is a cutaway view of an embodiment of a drill string comprising a battery module.

FIG. 3 is a perspective view of an embodiment of a battery module.

FIG. 4a is a perspective view of an embodiment of a stack of rechargeable batteries.

FIG. 4b is a perspective view of another embodiment of a stack of rechargeable batteries.

FIG. 5 is a cross-sectional exploded view of an embodiment of a rechargeable battery.

FIG. 6a is a cross-sectional view of an embodiment of a rechargeable battery.

FIG. 6b is a cross-sectional view of an embodiment of a rechargeable battery.

FIG. 6c is a cross-sectional view of an embodiment of a rechargeable battery

FIG. 7a is a cross-sectional view of an embodiment of a rechargeable battery.

FIG. 7b is a cross-sectional view of an embodiment of a rechargeable battery.

FIG. 8a is a cross-sectional view of an embodiment of a rechargeable battery.

FIG. 8b is a cross-sectional view of an embodiment of a rechargeable battery.

FIG. 9a is a cross-sectional view of an embodiment of a rechargeable battery.

FIG. 9b is a cross-sectional view of an embodiment of a rechargeable battery.

FIG. 10a is a perspective view of an embodiment of a rechargeable battery stack in a rocket.

FIG. 10b is a cutaway view of an embodiment of a rechargeable battery stack in a vehicle.

FIG. 11a is a cross-sectional view of an embodiment of a rechargeable battery.

FIG. 11b is a cross-sectional view of an embodiment of a rechargeable battery.

FIG. 12 is a cross-sectional view of an embodiment of a rechargeable battery.

FIG. 13 is a cross-sectional view of an embodiment of a rechargeable battery.

### DETAILED DESCRIPTION OF THE INVENTION AND THE PREFERRED EMBODIMENT

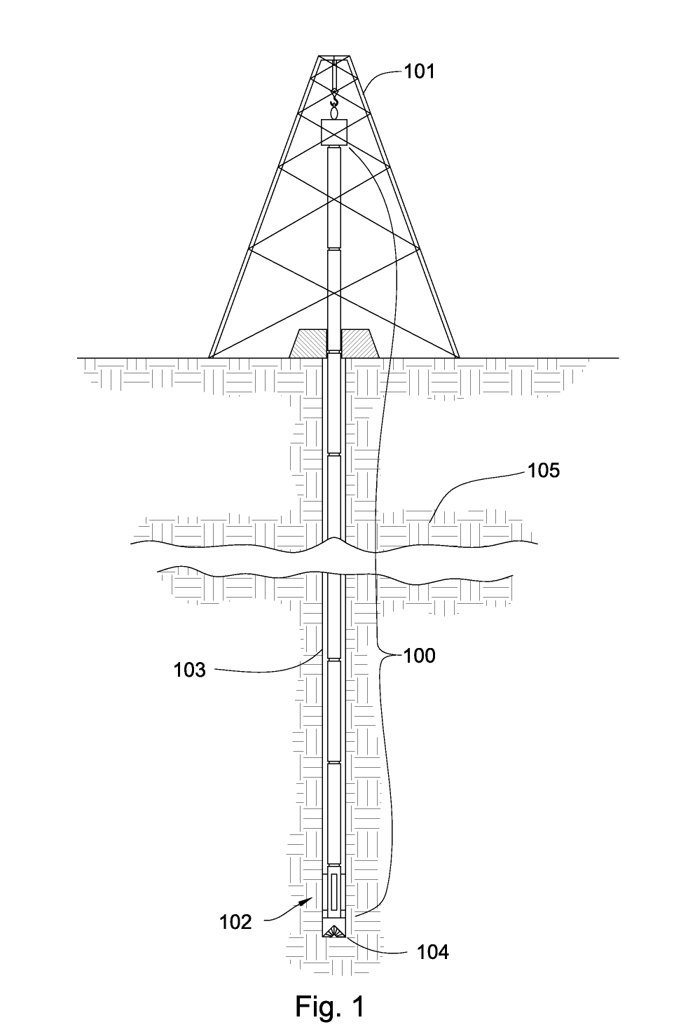

Moving now to the figures, FIG. 1 displays a cutaway view of an embodiment of a downhole drill string 100 suspended from a drill rig 101. A downhole assembly 102 may be located at some point along the drill string 100 and a drill bit 104 may be located at the end of the drill string 100. As the drill bit 104 rotates downhole the drill string 100 may advance farther into soft or hard earthen formations 105. The downhole assembly 102 and/or downhole components may comprise data acquisition devices which may gather data. Further, surface equipment may send data and/or power to downhole tools and/or the downhole assembly 102.

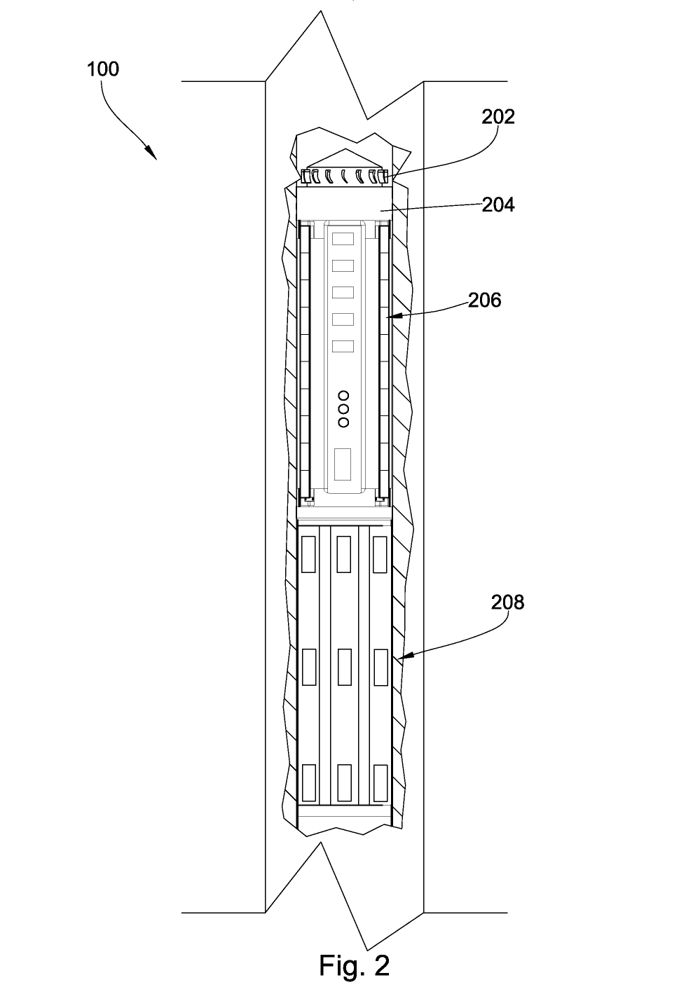

FIG. 2 is a cutaway view of an embodiment of a drill string comprising a turbine 202 and generator 204 in electrical connection to a battery module 206 and a tool module 208. The turbine 202, generator 204, battery module 206, and tool module 208 may comprise an outer diameter less than the inner diameter of the drill string. The tool module may be disposed inside the drill string adjacent to the drill string collar to help prevent axial movement. The battery module 206 may be disposed adjacent to the tool module 208 and the turbine 202 and generator 204 may be disposed adjacent to the battery module 206.

The tool module 208 may comprise a plurality of sensors and receivers used to expedite the drilling process. The sensors and receiver may comprise resistivity transmitters, resistivity receivers, nuclear sources, scintillators, geophones, seismic/sonic sources, accelerometers, gamma ray/neutron detectors, calipers or other receiving/transmitting devices. The battery module 206 may form a fluid seal with the tool module 208. The battery module 206 may provide power to the tool module 208 when desired.

The battery module 206 may form a fluid seal with the inner diameter of the drill string 100. The generator 204 may be driven by the turbine 202. As drilling fluid passes over the turbine blades, the turbine drive rotate the generator creating a source of power to recharge the battery module. The fluid may continue through internal passages of the battery and tool and continue to flow through the tool string.

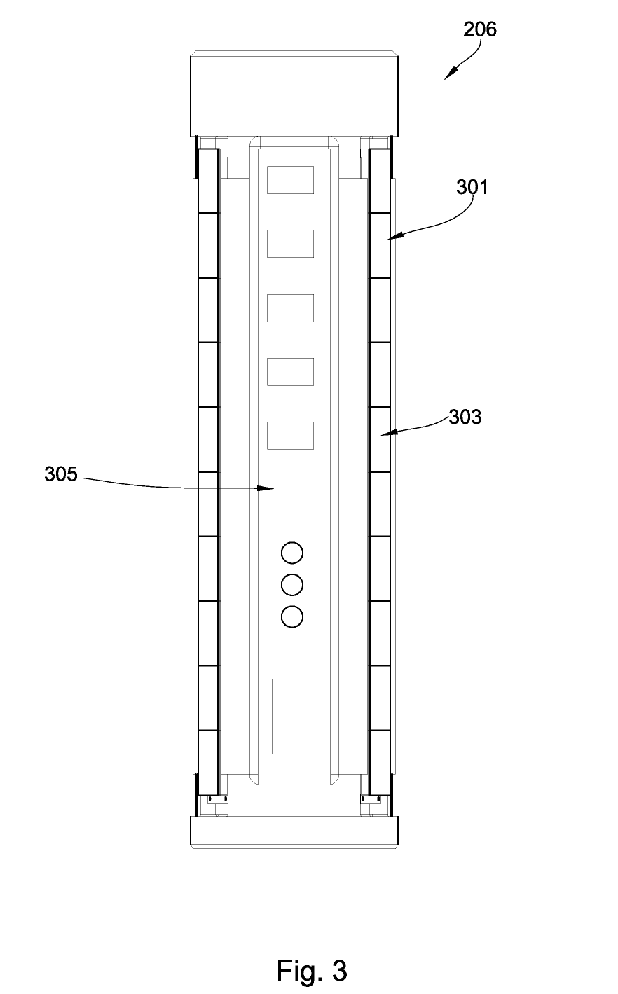

FIG. 3 is a perspective view of an embodiment of a battery module 206. The battery module 206 may comprise an inner and outer diameter. The inner diameter may permit fluid to flow through the module while the outer diameter may form a fluid seal with the inside diameter of the drill string. A plurality of rechargeable battery stacks 301 and a controller board 305 may be disposed axially along the circumference of the battery module 206 between the inner and outer diameter. The rechargeable battery stacks 301 may comprise a plurality of batteries 303 connected in series. The rechargeable battery stacks 301 may be electrically connected in parallel to the controller board 305. The controller board 305 may enable the battery module to act like a single higher capacity rechargeable battery.

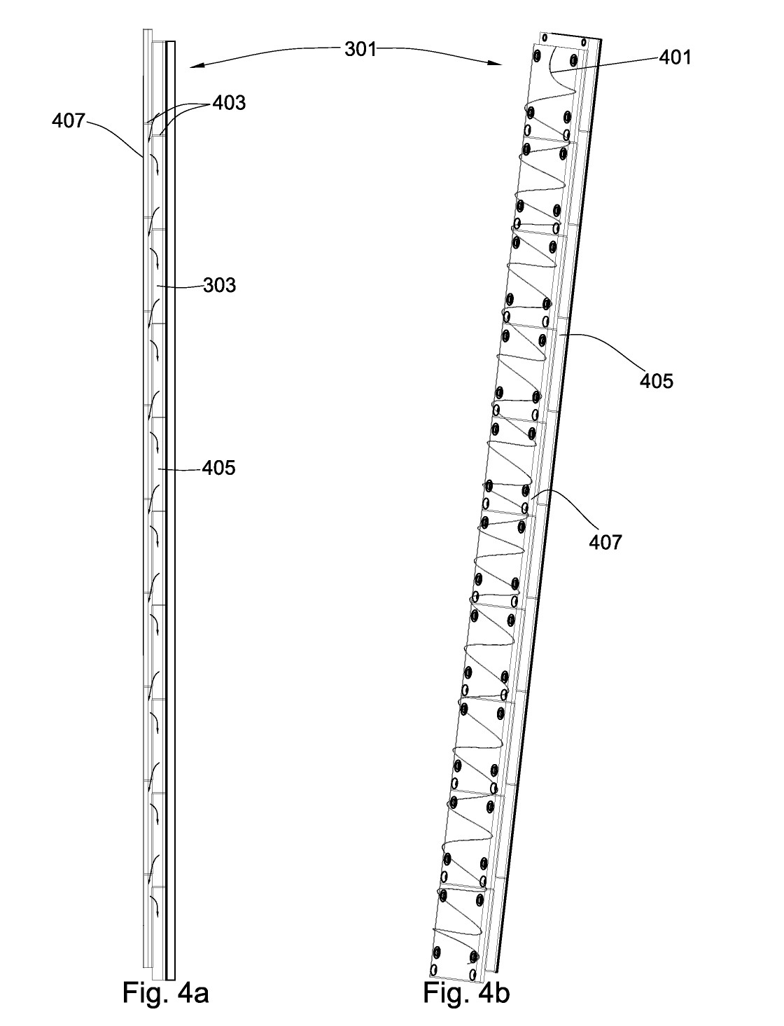

FIGS. 4a and 4b are perspective views of an embodiment of a rechargeable battery stack 301. The rechargeable battery stack 301 may comprise a plurality of batteries 303 disposed adjacent to one another. The batteries 303 may comprise high temperature batteries. High temperature batteries may comprise an electrolyte mixture which only functions at high temperatures. At least one heating element 401 may be disposed adjacent to the rechargeable battery stack and an insulation layer may surround the at least one heating element 401 and the rechargeable battery stack 301. The insulation layer may comprise silica aerogel or a vacuum. The at least one heating element 401 may receive power directly from the generator 204. The at least one heating element 401 and insulation may enable the batteries to reach an optimal operating temperature. An insulation layer 403 may also be disposed between each rechargeable battery 303 such that current is allowed to flow from the positive terminal 405 of one rechargeable battery 303 to the negative terminal 407 of the next rechargeable battery 303 creating a series connection between individual rechargeable batteries 303.

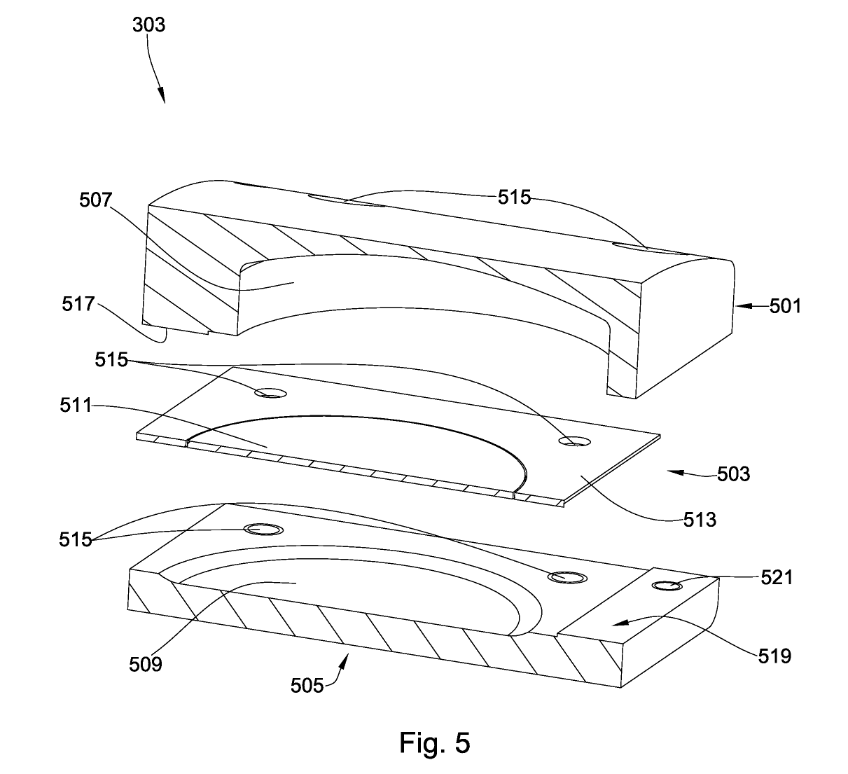

FIG. 5 is a cross-sectional exploded view of an embodiment of a rechargeable battery 303. The rechargeable battery 303 may comprise a cathode housing 501, a moveable membrane 503, and an anode housing 505. A cathode cavity 507 may be formed in the cathode housing 501 and an anode cavity 509 may be formed in the anode housing 505. The cathode and anode housing 501, 505 may comprise stainless steel, nickel 200, or any electrically conductive material which may resist high temperatures.

The moveable membrane 503 may comprise a first and second material 511, 513. The first material 511 may comprise NaSICON, β″ alumina, or other solid electrolyte material. The second material 513 may comprise a flexible material that can resist high temperatures. The first material 511 may be bonded to the second material 513. When the rechargeable battery 303 is constructed, the first and second material 511, 513 may form a seal between the anode cavity 509 and cathode cavity 507. The rechargeable battery 303 may be constructed by aligning holes 515 from the cathode housing 501, moveable membrane 503, and anode housing 505 and inserting a mass which may lock each piece in place. The rechargeable battery 303 may have an upper and lower shelf 517, 519. The upper shelf may be formed from the cathode housing and the lower shelf may be formed from the anode housing. By aligning holes 521 to a second battery and inserting a mass which may be used to lock the two rechargeable batteries 303 together a series connection may be formed between the rechargeable batteries 303.

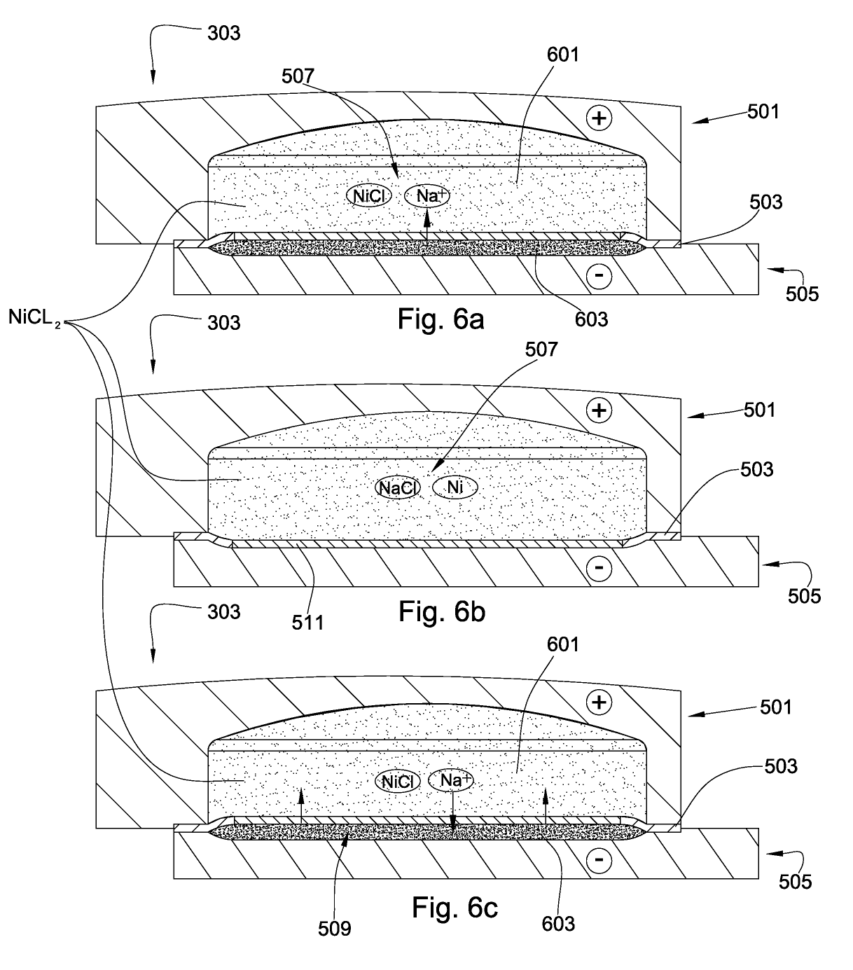

FIGS. 6a, 6b, and 6c are cross-sectional views of an embodiment of a rechargeable battery 303. FIG. 6a discloses a rechargeable battery 303 in the process of discharging, FIG. 6b discloses a rechargeable battery 303 in a discharged state, and FIG. 6c discloses a rechargeable battery 303 in the process of charging. The rechargeable battery 303 comprises a cathode cavity 507 and an anode cavity 509 separated by a moveable membrane 503. The anode cavity 509 may be filled with a combination of sodium metal and alloying elements. In the charged state, the cathode cavity 507 may contain nickel chloride while the anode cavity 509 may comprise sodium metal 603.

Under normal operation the cathode housing 501 is a positive terminal and the anode housing 505 is a negative terminal. Electrons may collect on the negative terminal and when connected to a circuit may flow away from the rechargeable battery 303. As the battery discharges, the sodium atoms may be ionized and the sodium ions may pass through the moveable membrane 503 into the cathode cavity 507. The sodium ions in the cathode cavity 507 may chemically react with the nickel chloride and form sodium chloride and nickel. As the sodium ions pass through the moveable membrane 503, the volume of the cathode cavity 507 may increase and the volume of the anode cavity 509 may decrease. This may cause the moveable membrane 503 to shift to accommodate the change in volume.

When the rechargeable battery 303 reaches a stage where there is substantially no sodium metal remaining in the anode cavity 509 and the cathode cavity 507 comprises a substantial portion of the sodium chloride and nickel then the rechargeable battery 303 is considered to be discharged.

To recharge the battery, the voltage difference across the positive and negative terminals is increased by an external energy source that supplies electrical current. The bonds between the sodium chloride may be weakened allowing the nickel ions to replace the sodium creating nickel chloride and sodium ions. The sodium ions may cross the moveable membrane 503 to the anode cavity increasing the volume of the anode cavity 509 while decreasing the volume of the cathode cavity 507 and causing the moveable membrane 503 to shift to accommodate the changes in volume. The sodium ions in the anode cavity 509 may combine with electrons to form liquid sodium metal until a substantial portion of the sodium in the battery is located in the anode cavity 509 and the battery is considered charged.

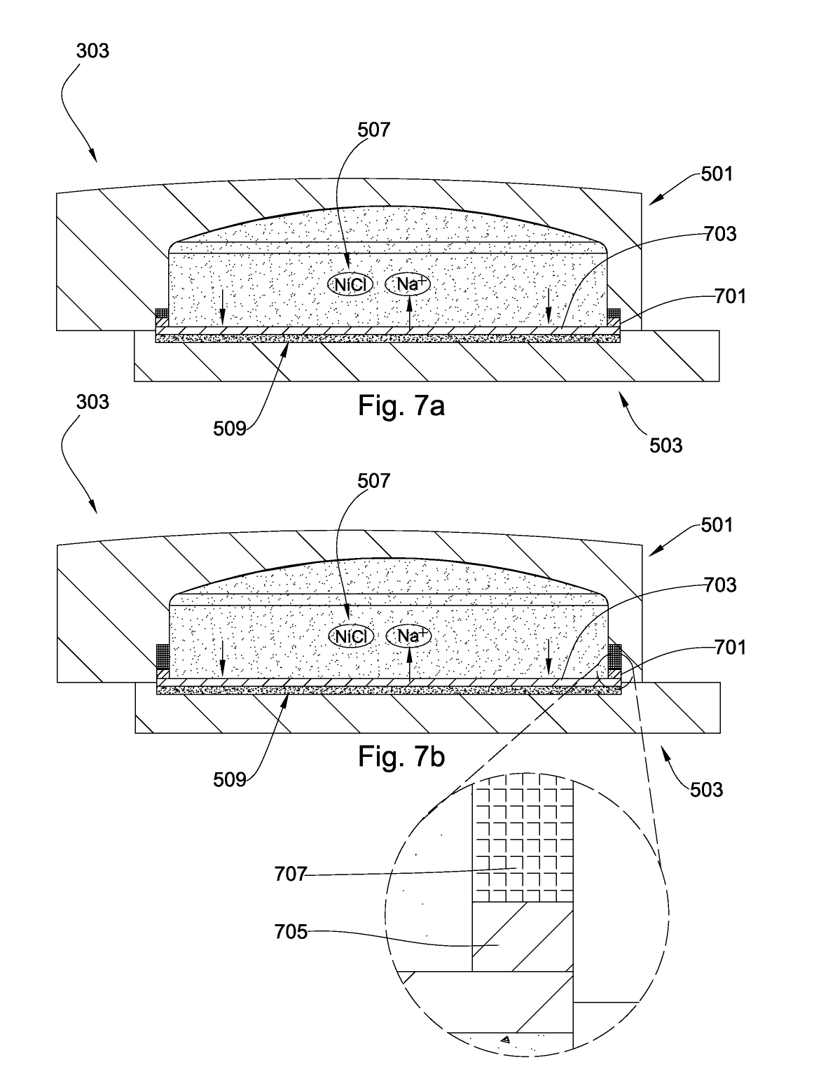

FIGS. 7a and 7b are a cross-sectional view of an embodiment of a rechargeable battery 303. The rechargeable battery 303 may comprise a moveable membrane comprising a solid electrolyte material. The moveable membrane 703 may be disposed within a groove 701 designed to allow vertical motion without compromising the fluid seal between the cathode and anode cavities 507, 509. The groove 701 may comprise a compressible material 705 adjacent to a high temperature plastic 707. The high temperature plastic 707 may form a seal with the moveable membrane 703. The groove 701 may allow for the moveable membrane 701 to move vertically. The vertical movement may allow the volume of the anode cavity 509 to decrease while increasing the volume of the cathode cavity 507 and vice versa. In some embodiments, no groove/protrusion embodiment is incorporated to guide the membrane as it moves.

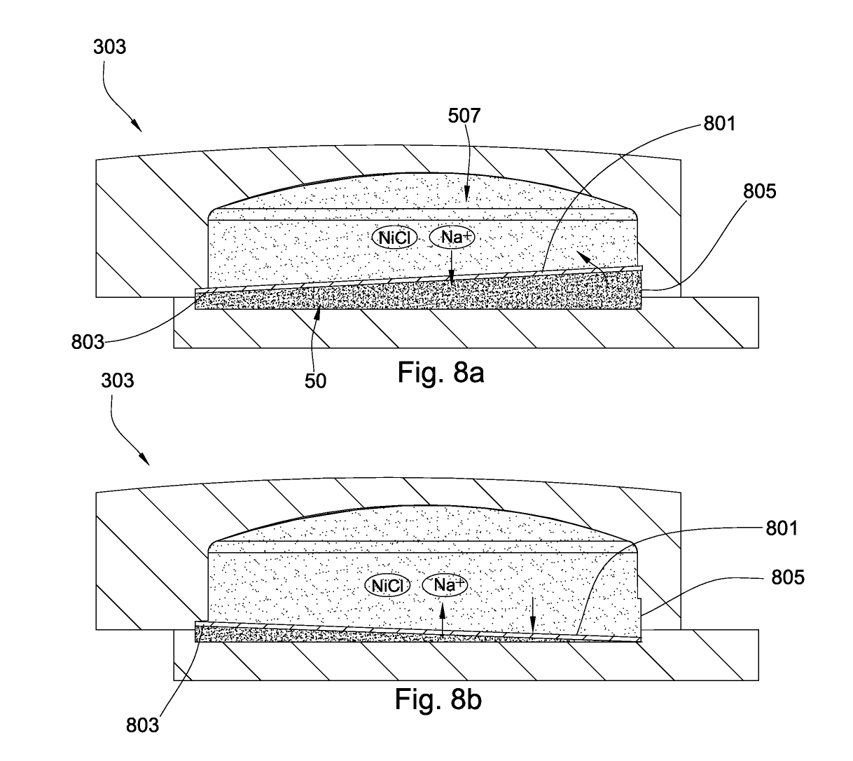

FIGS. 8a and 8b are a cross-sectional view of an embodiment of a rechargeable battery 303. The rechargeable battery 303 may comprise a moveable membrane 801 comprising a solid electrolyte material. The moveable membrane 801 may be disposed within the rechargeable battery 303 with a first end attached to a pivot 803 and the second end adjacent to a curving groove 805. The pivot and curving groove 803, 805 may provide a liquid seal between the cathode and anode cavities while permitting an increase in volume of the anode cavity and a decrease of the cathode cavity.

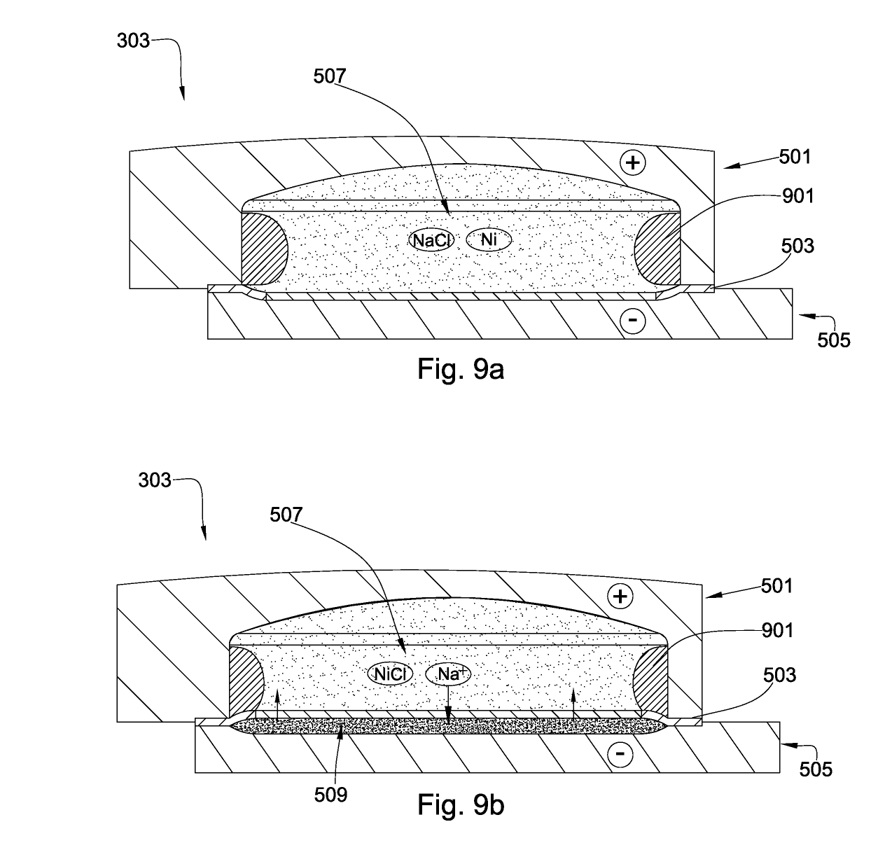

FIGS. 9a and 9b are a cross-sectional view of an embodiment of a rechargeable battery 303. FIG. 9a discloses the rechargeable battery 303 in a discharged state and FIG. 9b discloses the rechargeable battery in a charging state. The rechargeable battery 303 disclosed may further comprise a compressible mechanism such as closed cell foam, a gas-filled bladder, or compressible material 901 disposed within the cathode cavity 507. The closed cell foam 901 may also be disposed within the anode cavity or both the anode and cathode cavities. The foam in each cavity may be comprised of different materials. In the present embodiment, sodium ions may cross the membrane into the cathode cavity 509 and combine with electrons to form liquid sodium metal. When the liquid sodium metal is formed, expansion may occur in the anode compartment 509 that exceeds contraction in the cathode compartment 507. This may generate an increase in the total volume of active materials within the rechargeable battery 303. The closed cell foam 901 in either or both compartments may compress to accommodate the increase in volume of the active materials.

The closed cell foam or other compressible mechanisms may reduce asymmetric forces to the ceramic separator during the volume changes. In downhole use, accelerations are high and failure is more likely than in stationary applications.

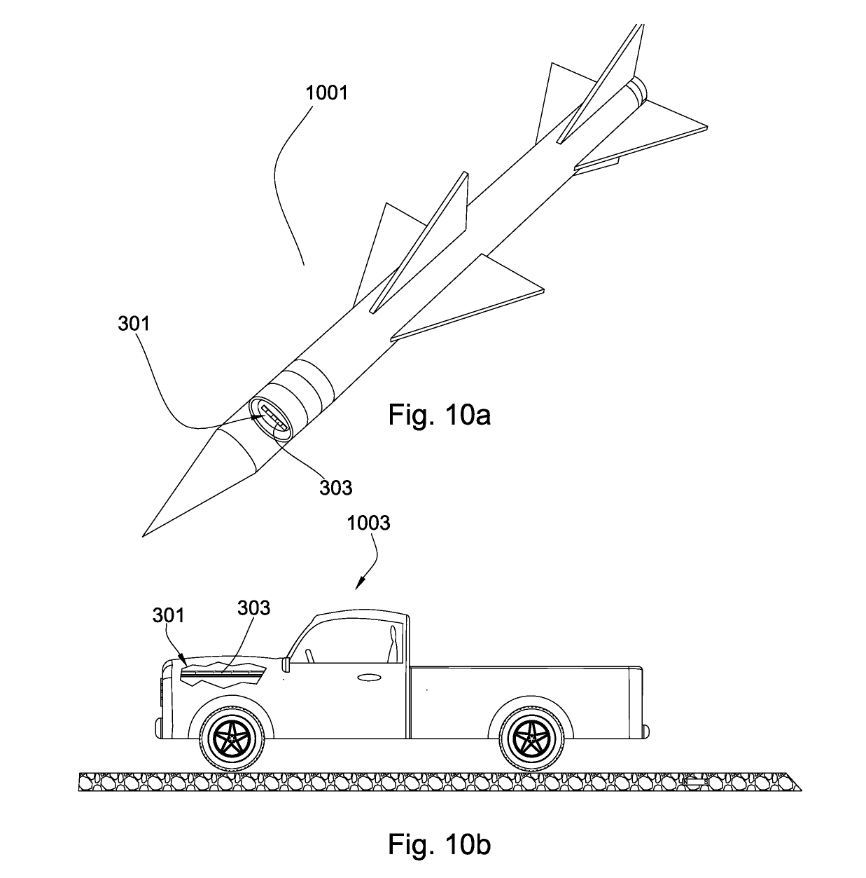

FIGS. 10a and 10b disclose alternative applications for the rechargeable battery 303. The rechargeable battery 303 may function efficiently at higher temperature ranges than currently used rechargeable batteries. This may have the benefit of increased performance without the loss of battery life. FIG. 10a discloses a cutaway view of the rechargeable battery stack 301 in a rocket 1001. Rockets 1001 tend to function at relatively high temperatures. This may be caused by the rocket itself, as a product of propulsion, or it may also be caused from wind friction as the rocket 1001 is travelling at high speeds through the air. FIG. 10b discloses a cutaway view of a rechargeable battery stack 301 in an automobile 1003. The rechargeable battery 303 may generally be used in gas-electric hybrids or gas automobiles. The battery stack 301 may not need any form of protection from the heat of the engine allowing for more diverse construction of automobiles 1003.

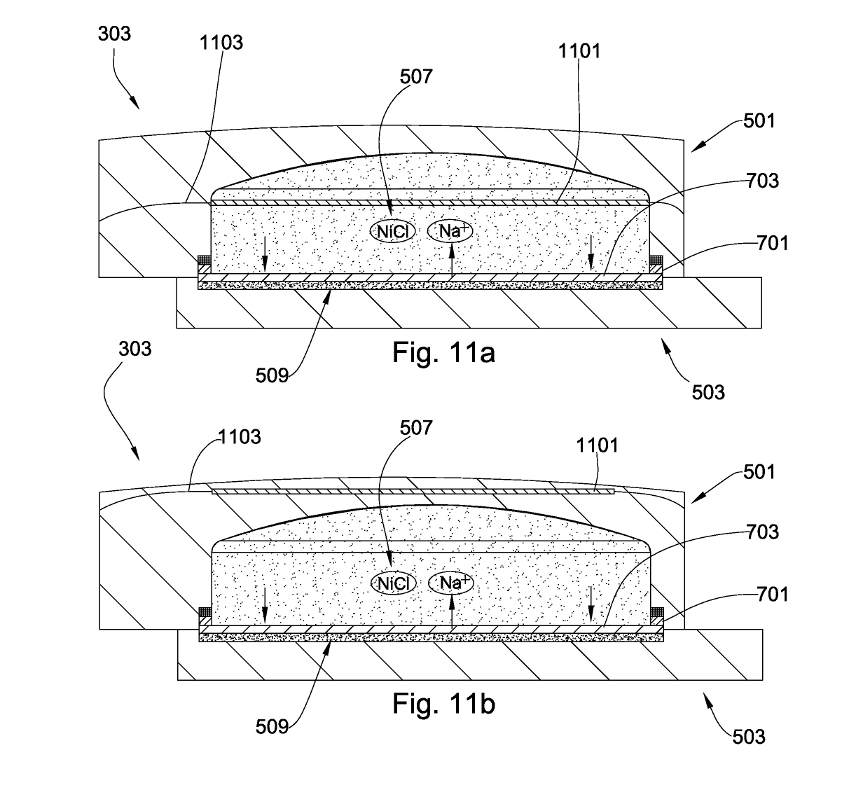

FIGS. 11a and 11b are cross-sectional views of embodiments of a rechargeable battery 303 comprising a heating element 1101 disposed internally. FIG. 11a discloses a heating element disposed within the cathode cavity 507 and FIG. 11b discloses a heating element 1101 disposed in the cathode housing 501. The heating element may be a resistive heating element or other active heater. The heating element may actively heat the constituents in the anode and/cathode cavities.

The battery may function optimally when the electrolyte is in a molten state. In cooler environments, some electrolyte may solidify. In some applications, even high temperature applications, the heater may more effectively increase the battery's internal temperature than relying on ambient temperatures of the environment where the battery is located

In FIG. 11a, the heating element may comprise a resistant material with a high melting point surrounded in an electrically insulating material 1106. An insulated wire 1103 may extend from the heating element 1101 into the cathode housing 501. A fluid seal 1105 may be disposed where the insulated wire 1103 enters the cathode housing 501 preventing electrolyte leaks. The insulation may prevent an electrical current in the wire from shorting the electrolyte and the housing. In some embodiments, an electrical source for the heating element is the battery 303, another battery, a generator, a thermoelectric device, or an external power source. While FIG. 11a discloses the heating element in the cathode housing, the scope of the invention includes embodiments with the heating element disposed within the anode cavity and/or housing.

In FIG. 11b, an insulated wire may extend from the heating element through the cathode housing. The wire may be electrically insulated to separate the current flowing through the wire and the current flowing through the battery. As the cathode housing's temperature rises, this heat will radiate into the cathode housing to cause the electrolyte to be in a molten state.

In some embodiments, sensors may be incorporated into the battery to determine if the internal battery is hot enough without the contribution of an active heating element. In situations where the battery is hot enough, the heating element may turn off. Conversely, if the sensor measures that the battery's internal temperature should increase, the heating element may turn on. In some embodiments, the heating element is configured to produce multiple thermal outputs, so the heating element may contribute only the energy into the battery that is effective or necessary.

In some embodiments, the heating element may be flat and straight. In some embodiments, the heating element may comprises a geometry configure to occupy a greater volume or an increase in surface area to more efficiently heat the interior of the battery. For example, the heating element may comprise a spiral shape. In some embodiments, the heating element may also be a biasing mechanism that is in mechanical communication with the membrane and in certain circumstance may assist with moving the membrane. In some embodiments, the heating element may comprise a plurality of wires that are interwoven giving the heating element additional flexibility.

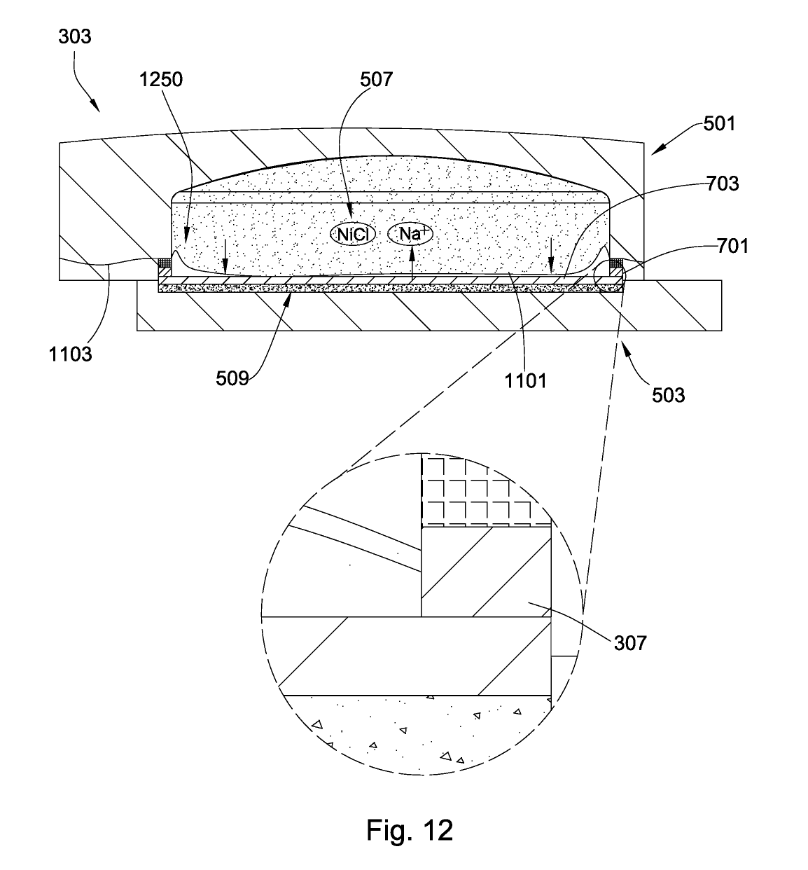

FIG. 12 is a cross-sectional view of an embodiment of a rechargeable battery 303 comprising a heating element internally disposed proximate the membrane. In some embodiments, the membrane is rigidly fixed to the housings. In other embodiments, the membrane is configured to move with respect to the housings. The heating element may comprise a plurality of wires 1201 surrounded by an electrically insulating material. The plurality of wires 1201 may comprise a resistive material with a high melting point. The plurality of wires 1201 may be disposed adjacent to a moveable membrane 1203 and may comprise a length greater than the length across the membrane. The extra length 1250 of wire may compensate for the movement of the membrane 1203 as the battery 303 charges and discharges. In some embodiments, the heating element are embedded or deposited on the membrane itself.

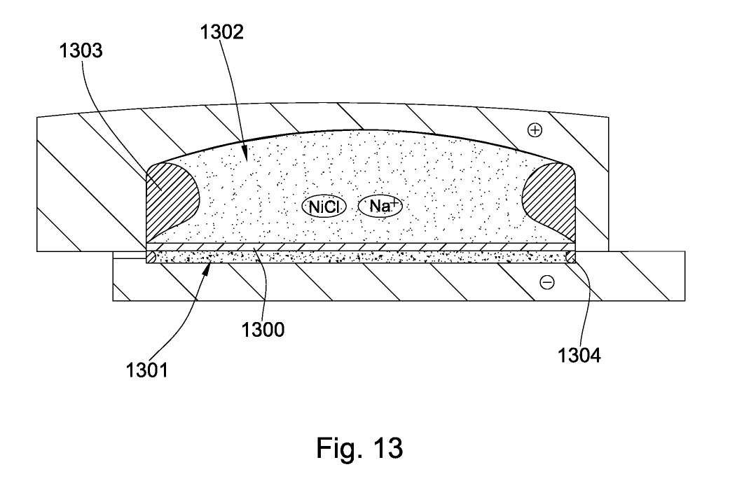

FIG. 13 discloses an immoveable membrane 1300 rigidly attached to the battery housings. The membrane separates the cathode and anode cavities 1302, 1301. A compressible mechanism is disposed within both the cathode and anode cavities 1302, 1301. As the battery's charge is depleted, then compressible mechanism 1303, 1304 fills the volume gaps created by the shifting chemicals between the cavities. The compressible mechanism may be a closed cell foam, rubber, an elastic material, a gas filled bladder, a resilient member, or combinations thereof.

Whereas the present invention has been described in particular relation to the drawings attached hereto, it should be understood that other and further modifications apart from those shown or suggested herein, may be made within the scope and spirit of the present invention.

What is claimed is:

1. A battery, comprising:
a cathode cavity formed in a cathode housing and an anode cavity in an anode housing;
a moveable membrane disposed between the cathode cavity and the anode cavity; and
the cavities are filled with an electrolyte.

2. The battery of claim 1, wherein the moveable membrane is flexible.

3. The battery of claim 1, wherein the moveable membrane is rigid and a perimeter of the membrane is attached to a flexible material that connects with the cathode housing, the anode housing, or combinations thereof.

4. The battery of claim 3, wherein the membrane comprises NaSICON, β″-alumina, solid electrolyte material, or combinations thereof.

5. The battery of claim 1, wherein the moveable membrane is rigid and a perimeter of the membrane comprises a protrusion that is guided by a slot formed in the cathode housing, the anode housing, or combinations thereof.

6. The battery of claim 1, wherein the moveable membrane is rigid and a portion of a perimeter of the membrane forms a hinge with the cathode housing, the anode housing, or combinations thereof.

7. The battery of claim 1, wherein the cathode and anode housing comprise a conductive material.

8. The battery of claim 1, wherein a compressible mechanism is disposed within the cathode and/or anode cavity.

9. The battery of claim, 8 where the compressible mechanism is closed cell foam.

10. The battery of claim 9, wherein the closed cell foam comprises up to 50% of the volume of the cathode cavity.

11. The battery of claim 1, wherein the cathode and anode cavities comprise substantially no direct contact between active materials and volume containing gas or vapor.

12. The battery of claim 1, wherein the electrolyte comprise a mixture containing sodium, nickel, and chlorine.

13. The battery of claim 1, further comprising at least one heating element adjacent to the cathode or anode housing.

14. The battery of claim 12, further comprising a layer of thermal insulation surrounding the at least one heating element and the cathode and anode housing.

15. The battery of claim 1, wherein a cathode housing of a first rechargeable battery is in connection with the anode housing of a second rechargeable battery.

16. The battery of claim 14, further comprising an electrical insulator between the cathode housing of the first and second rechargeable battery.

17. The battery of claim 14, further comprising an electrical insulator between the anode housing of the first and second rechargeable battery.

18. The battery of claim 1, further comprising an electrical connection to a downhole generator.

19. A rechargeable battery, comprising:
a cathode cavity formed in a cathode housing and an anode cavity in an anode housing;
a fixed membrane disposed between the cathode cavity and the anode cavity; and
the anode and/or cathode cavities comprise compressible mechanism;
the cavities are filled with an electrolyte.

20. The battery of claim 19, wherein the compressible mechanism comprises a foam.
